(19) United States
(12) Patent Application Publication
(10) Pub. No.: US 2024/0236155 A9
(43) Pub. Date: Jul. 11, 2024

(54) SYSTEMS, METHODS, AND COMPUTER PROGRAM PRODUCTS FOR PROVIDING SIMULATOR AUGMENTED CONTENT SELECTION

(71) Applicant: Spotify AB, Stockholm (SE)

(72) Inventors: Joseph Cauteruccio, Boston, MA (US); Mehdi Ben Ayed, New York, NY (US); Zhenwen Dai, London (GB)

(73) Assignee: Spotify AB, Stockholm (SE)

(21) Appl. No.: 18/049,360

(22) Filed: Oct. 25, 2022

(51) Int. Cl. H04L 65/1069; H04L 65/613

(52) U.S. Cl. CPC H04L 65/1069; H04L 65/613

(57) ABSTRACT

Simulator augmented content selection is provided by initializing a content selection object according to session initialization parameter values associated with a simulated media content playback session. The content selection object corresponds to a candidate content selection machine learning model trained to predict selectable content media items for at least one simulated user. A simulated session including a sequence of predicted simulated user next actions and one or more predicted sets of selectable content items are generated by applying a simulated user model to content items identified by the initialized content selection object, where the simulated user model is trained to predict a next action of the simulated user in response to a simulated playback input received from the simulated user and each set of the selectable content items are correlated to each next action in the sequence of predicted simulated user next actions.

### TECHNICAL FIELD

Example aspects described herein relate generally to machine learning systems, and more particularly to simulators for deriving content selection strategies used in content selection systems.

### BACKGROUND

Exploration is a pivotal component in any real-world content selection system. However true exploration means potentially exposing users to items that, all things being equal, could induce a negative reaction. Performing an exploration procedure on real users can not only erode the users' trust in a content selection product, it can result in biased information resulting from factors such as survivor bias (also referred to as survivorship bias, survival bias or immortal time bias). Survivor bias is the logical error of concentrating on the items that made it past some selection process and overlooking those items that did not, typically because of their lack of visibility. This can lead machine learning systems or other components in content selection systems to generate incorrect results or conclusions (e.g., in the form of probabilities).

One known off-the-shelf simulator solution for recommender systems (RSs) is RecSim. RecSim is a platform for authoring simulation environments for RSs that support sequential interaction with users. New environments can be created that reflect particular aspects of user behavior and item structure at a level of abstraction suited for reinforcement learning (RL) and RS techniques in sequential interactive recommendation problems. The environments can be configured that vary assumptions about: user preferences and item familiarity; user latent state and its dynamics; and choice models and other user response behavior. However, RecSim primarily focuses on the generics of recommender simulation (some number of items, sequential recommendations and evaluations). Consequently, RecSim is not industrially robust (rather they are research codebases) and it does not readily allow for integration of session exploration (e.g., exploring different user-set combinations), multiple integrations of different environment models, session heuristics (e.g., skip behavior, termination heuristics, fetching of the production parameters to make sure that simulated sessions accurately match, etc.).

OpenAI Gym, also used for reinforcement learning applications, includes a collection of benchmark problems that expose a common interface, and a website where people can share their results and compare the performance of algorithms. OpenAI Gym focuses on the episodic setting of reinforcement learning, where an agent's experience is broken down into a series of episodes. In each episode, the agent's initial state is randomly sampled from a distribution, and the interaction proceeds until the environment reaches a terminal state. The goal in episodic reinforcement learning is to maximize the expectation of total reward per episode, and to achieve a high level of performance in as few episodes as possible. This solution also is focused only on training in an experimental setting. Like RecSim, OpenAI Gym also is not industrially robust, and does not easily allow for integration of session exploration, multiple integrations of different environment models, or session heuristics.

There is a need, therefore, for a solution that allows for easy mode switching between training, offline evaluation, and online (e.g., production) deployment.

### SUMMARY

Generally, the embodiments presented herein are directed to a system that provides user simulation, session simulation, and the ability to test item selection systems both offline and online. In an example embodiment, a simulator is provided for simulating the presentation of media content items to a user throughout a media content playback session (referred to herein simply as a “session”). In some embodiments, the user is a simulated user, and the simulator presumes the simulated user interacts, via a device, with a global set of media content items. The simulator simulates a sequence of media content items the simulated user might select, given the global set of media content items as well as based on various selections an automated content selection system might make. The simulator thus simulates at any given instance of time what the simulated user might select given a sequence of media content items presented to the simulated user. The simulator can also simulate various distinct potential sequences. In addition, the system enables the ability to operate the automated content selection system in an online environment (e.g., in a production environment using real users).

In an example embodiment, a system for providing a simulator augmented content selection involves a content selection object generator configured to generate a content selection object corresponding to a candidate content selection machine learning model trained to predict one or more selectable content media items for at least one simulated user; a simulated user model selector configured to provide a simulated user model corresponding to a simulated user model trained to predict a next action of the at least one simulated user in response to a simulated playback input received from the at least one simulated user; a session initializer configured to initialize the content selection object according to a plurality of session initialization parameter values, thereby generating an initialized content selection object, where the plurality of session initialization parameter values correspond to a simulated media content playback session; and an augmented content selection simulator configured to apply the simulated user model to content items identified by the initialized content selection object to generate a simulated session including a sequence of predicted simulated user next actions and one or more predicted sets of selectable content items, each set of the one or more selectable content items correlated to each next action in the sequence of predicted simulated user next actions.

In some embodiments, the system further involves a candidate content selection simulator configured to register a plurality of candidate content selection machine learning models, wherein the candidate content selection machine learning model is obtained by a selection of one of the plurality of candidate content selection machine learning models, wherein each of the plurality of candidate content machine learning models is trained to uniquely predict one or more selectable content media items for at least one simulated user.

In some embodiments, the system further involves an input/output interface configured to receive a selection of one of the plurality of candidate content selection machine learning models.

In some embodiments, the system further involves a candidate content selection simulator configured to register a plurality of simulated user models, wherein the simulated user model is obtained by a selection of one of the plurality of simulated user models, wherein each simulated user model is trained to uniquely predict a next action of the at least one simulated user in response to a simulated playback input received from the at least one simulated user.

In some embodiments, the system further involves an input/output interface configured to receive a selection of one of the plurality of simulated user models.

In some embodiments, the simulated user model selector further configured to: generate the simulated user model by applying any one of (i) a plurality of predefined attributes of the one or more simulated users, (ii) a plurality of predefined attributes of media content items, or (iii) a combination of (i) and (ii), to the selected simulated user model.

In some embodiments, the session initializer configured to: receive interaction data associated with a plurality of non-simulated users and a plurality of production initialization parameters, and initialize the content selection object by applying the plurality of session initialization parameter values to the plurality of production initialization parameters, thereby generating the initialized content selection object.

In some embodiments, the session initializer is further configured to: select a recorded session of a real user, and initialize the candidate content selection machine learning model to a particular time within the recorded session.

Another embodiment, is a method for providing a simulator augmented content selection involving the steps of receiving a content selection object corresponding to a candidate content selection machine learning model trained to predict one or more selectable content media items for at least one simulated user; receiving a simulated user model corresponding to a simulated user model trained to predict a next action of the at least one simulated user in response to a simulated playback input received from the at least one simulated user; initializing the content selection object according to a plurality of session initialization parameter values, thereby generating an initialized content selection object, where the plurality of session initialization parameter values correspond to a simulated media content playback session; and applying the simulated user model to content items identified by the initialized content selection object to generate a simulated session including a sequence of predicted simulated user next actions and one or more predicted sets of selectable content items, each set of the one or more selectable content items correlated to each next action in the sequence of predicted simulated user next actions.

In some embodiments, the method further involves registering a plurality of candidate content selection machine learning models; and receiving a selection of one of a plurality of candidate content selection machine learning models to obtain the candidate content selection machine learning model, wherein each of the plurality of candidate content machine learning models is trained to uniquely predict one or more selectable content media items for at least one simulated user.

In some embodiments, the method further involves registering a plurality of simulated user models; and receiving a selection of one of the plurality of simulated user models, to obtain the simulated user model, wherein each simulated user model is trained to uniquely predict a next action of the at least one simulated user in response to a simulated playback input received from the at least one simulated user.

In some embodiments, the method further involves generating the simulated user model by applying any one of (i) a plurality of predefined attributes of the one or more simulated users, (ii) a plurality of predefined attributes of media content items, or (iii) a combination of (i) and (ii), to the selected simulated user model.

In some embodiments, the method further involves receiving interaction data associated with a plurality of non-simulated users and a plurality of production initialization parameters; and initializing the content selection object by applying the plurality of session initialization parameter values to the plurality of production initialization parameters, thereby generating the initialized content selection object.

In some embodiments, the method further involves selecting a recorded session of a real user; and initializing the candidate content selection machine learning model to a particular time within the recorded session.

Another embodiment is a non-transitory computer-readable medium having stored thereon one or more sequences of instructions for causing one or more processors to perform: receiving a content selection object corresponding to a candidate content selection machine learning model trained to predict one or more selectable content media items for at least one simulated user; receiving a simulated user model corresponding to a simulated user model trained to predict a next action of the at least one simulated user in response to a simulated playback input received from the at least one simulated user; initializing the content selection object according to a plurality of session initialization parameter values, thereby generating an initialized content selection object, where the plurality of session initialization parameter values correspond to a simulated media content playback session; and applying the simulated user model to content items identified by the initialized content selection object to generate a simulated session including a sequence of predicted simulated user next actions and one or more predicted sets of selectable content items, each set of the one or more selectable content items correlated to each next action in the sequence of predicted simulated user next actions.

In some embodiments, the non-transitory computer-readable medium further has stored thereon a sequence of instructions for causing the one or more processors to perform: registering a plurality of candidate content selection machine learning models; and receiving a selection of one of a plurality of candidate content selection machine learning models to obtain the candidate content selection machine learning model, wherein each of the plurality of candidate content machine learning models is trained to uniquely predict one or more selectable content media items for at least one simulated user.

In some embodiments, the non-transitory computer-readable medium further has stored thereon a sequence of instructions for causing the one or more processors to perform: registering a plurality of simulated user models; and receiving a selection of one of the plurality of simulated user models, to obtain the simulated user model, wherein each simulated user model is trained to uniquely predict a next action of the at least one simulated user in response to a simulated playback input received from the at least one simulated user.

In some embodiments, the non-transitory computer-readable medium further has stored thereon a sequence of instructions for causing the one or more processors to perform: generating the simulated user model by applying any one of (i) a plurality of predefined attributes of the one or more simulated users, (ii) a plurality of predefined attributes of media content items, or (iii) a combination of (i) and (ii), to the selected simulated user model.

In some embodiments, the non-transitory computer-readable medium further has stored thereon a sequence of instructions for causing the one or more processors to perform: receiving interaction data associated with a plurality of non-simulated users and a plurality of production initialization parameters; and initializing the content selection object by applying the plurality of session initialization parameter values to the plurality of production initialization parameters, thereby generating the initialized content selection object.

In some embodiments, the non-transitory computer-readable medium further has stored thereon a sequence of instructions for causing the one or more processors to perform: selecting a recorded session of a real user; and

initializing the candidate content selection machine learning model to a particular time within the recorded session.

### BRIEF DESCRIPTION OF THE DRAWINGS

The features and advantages of the example embodiments of the invention presented herein will become more apparent from the detailed description set forth below when taken in conjunction with the following drawings.

FIG. 1 illustrates an example simulator augmented content selection system for providing augmented simulation for machine learning systems.

FIG. 2 depicts a simulator augmented content selection procedure for providing simulator augmented content selection in accordance with an example embodiment.

FIG. 3 depicts a registration and selection procedure for registering and selecting simulated user models and candidate content selection machine learning models in accordance with an example embodiment.

FIG. 4 depicts a content selection object initialization procedure for initializing content selection objects in accordance with an example embodiment.

FIG. 5A depicts a portion of an example system-flow for providing simulator augmented content selection in accordance with an example implementation.

FIG. 5B depicts a portion of an example system-flow for providing simulator augmented content selection in accordance with an example implementation.

FIG. 5C depicts a portion of an example system-flow for providing simulator augmented content selection in accordance with an example implementation.

### DETAILED DESCRIPTION

The example embodiments presented herein are directed to systems, methods, and non-transitory computer-readable medium products for providing augmented simulation for machine learning systems. Generally, the problem of live exploration is circumvented by building highly accurate simulators of user behavior and then, using these simulators, exposing one or more content selection systems to a vast array of potential user-context-item combinations, including those that fall drastically outside a given user's normal usage pattern. This allows a variety of hypothetical sessions to be simulated for both training and evaluation of content selection systems.

Although primarily described in the domain of media content selection systems, such as systems that select audio content (e.g., music, audiobooks or podcasts), video content (e.g., shows or movies), game content (e.g., video games), and virtual reality content, among other content, it should be appreciated that principles of the present disclosure can be applied outside of media content selection altogether and can be generally applied to improve machine learning systems which would benefit from the simulation of different various selection systems for simulated users, simulating next actions of the simulated users, the ability to initialize parameter values of simulated sessions, among others. Accordingly, after reading the following description, how to implement the following disclosure in alternative embodiments will be apparent to one skilled in the relevant art.

In an example embodiment, the simulator presents media content items to a simulated user in the context of a media content playback session, where the media content items are drawn from a global set of media content items in a sequence. The media content items are pulled from and ordered by a content item selection system (e.g., in the form of a playlist). The simulator receives input from the simulated user corresponding to simulated interactions by the simulated user with the media content items (e.g., a user might listen to a playlist and then stop, rewind, skip, forward, etc.). Together with knowledge about the simulated user and the media content items, the simulator applies a content selection model to predict a next action.

The simulator then dynamically revises the ordered media content items (e.g., playlist) based on the predicted next action.

In some embodiments, the simulator applies multiple content selection models to predict next actions associated with each content selection model, correspondingly. This allows various content selection models to be tested substantially concurrently. Similarly, sets of parameters defining different session environments can be applied to a content selection model.

A “session” as used herein generally refers to a period of substantially continuous consumption (e.g., listening, viewing, interacting) of one or more media content items with only one or more small breaks in time between each media content playback. A small break, for example, is an interruption of playback (e.g., listening to a playlist of music tracks) for a reason that does not reflect an intention of to cease the consumption of media content items, e.g., to take a bathroom break or respond to a relatively short phone call. In an example implementation, a small break is defined as a playback gap of less than about three minutes. A session can include the playback of the same media content item multiple times, even consecutively. A session can also persist across platforms (for example, from desktop device to a mobile device). In some implementations, a session corresponds to consumption of media content items for longer than about thirty (30) seconds.

As noted above, the embodiments described herein are applicable to various kinds of media content, such as audio content (e.g., music, audiobooks or podcasts), video content (e.g., shows or movies), game content (e.g., video games), and virtual reality content, among other content. A media content item is an item of media content, such as an audio content item, a video content item, or other types of media content, which may be stored in any format suitable for storing media content. Non-limiting examples of media content items include songs, albums, audiobooks, music videos, movies, television episodes, podcasts, other types of audio or video content, and portions or combinations thereof.

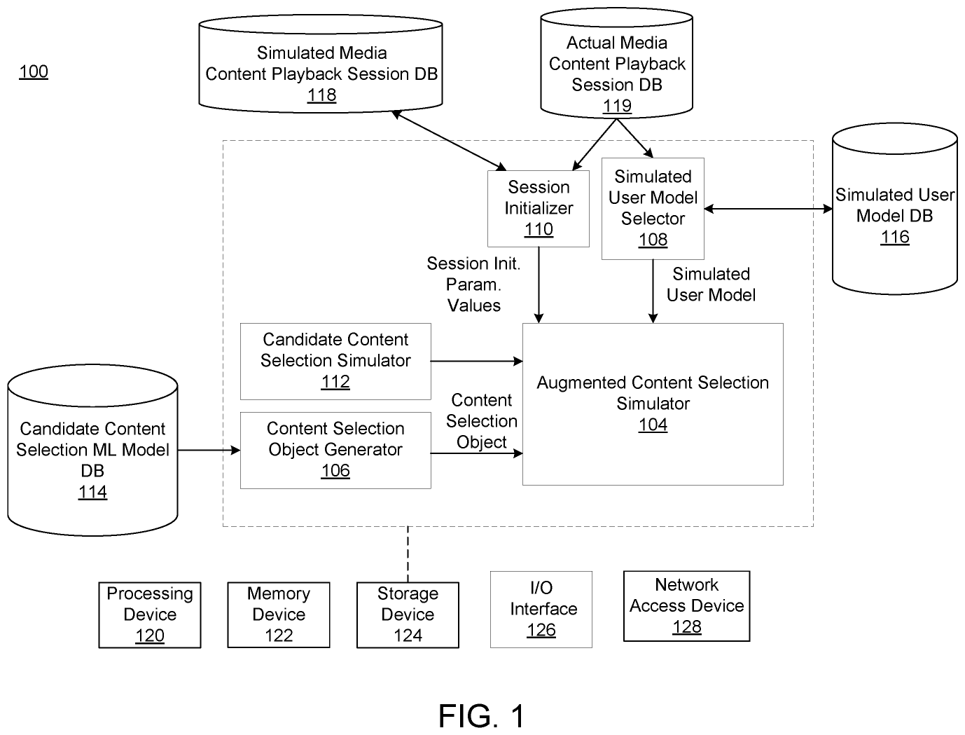

FIG. 1 illustrates an example simulator augmented content selection system 100 for providing augmented simulation for machine learning systems. In the example of FIG. 1, the simulator augmented content selection system 100 includes an augmented content selection simulator 104, a content selection object generator 106, a simulated user model selector 108, a session initializer 110, a candidate content selection simulator 112, a candidate content selection machine learning (ML) model database 114, a simulated user model database 116, a simulated media content playback session database 118, an actual media content playback session database 119, a processing device 120, a memory device 122, a storage device 124, an input/output (I/O) interface 126, and a network access device 128.

In an example embodiment, the processing device 120 also includes one or more central processing units (CPUs). In another example embodiment, the processing device 120 includes one or more graphic processing units (GPUs). In other embodiments, the processing device 120 may additionally or alternatively include one or more digital signal processors, field-programmable gate arrays, or other electronic circuits as needed.

The memory device 122 is a non-transitory computer-readable medium coupled to a bus that operates to store data and instructions to be executed by processing device 120. The instructions, when executed by processing device 120, cause the processing device to operate as the augmented content selection simulator 104, the content selection object generator 106, the simulated user model selector 108, the session initializer 110, and the candidate content selection simulator 112. The memory device 122 can be, for example, a non-transitory random-access memory (RAM) or other non-transitory dynamic storage device. The memory device 122 also may be used for storing temporary variables (e.g., parameters) or other intermediate information during execution of instructions to be executed by processing device 120.

The storage device 124 is a non-transitory nonvolatile storage device for storing data and/or instructions for execution by processing device 120. The storage device 124 may be implemented, for example, with a hard disk drive (HDD), solid state drive (SSD), magnetic disk drive, an optical disk drive, and the like. In some embodiments, the storage device 124 is configured for loading contents of the storage device 124 into the memory device 122.

I/O interface 126 includes one or more components which a user of the simulator augmented content selection system 100 can interact. The I/O interface 126 can include, for example, a touch screen, a display device, a mouse, a keyboard, a webcam, a microphone, speakers, a headphone, haptic feedback devices, or other like components.

Examples of the network access device 128 include one or more wired network interfaces and wireless network interfaces. Examples of such wireless network interfaces of a network access device 128 include wireless wide area network (WWAN) interfaces (including cellular networks) and wireless local area network (WLANs) interfaces. In other implementations, other types of wireless interfaces can be used for the network access device 128.

The network access device 128 operates to communicate with components outside the simulator augmented content selection system 100 over various networks. In some embodiments, candidate content selection machine learning (ML) model database 114, simulated user model database 116, simulated media content playback session database 118, and/or actual media content playback session database 119 are outside the simulator augmented content selection system 100 and accessible to simulator augmented content selection system 100 via network access device 128.

In some embodiments, content selection object generator 106 operates to generate a content selection object. A content selection object can be, for example, a set of rules, a plurality of heuristics, a reinforcement learning agent (RL-Agent), a machine learning model (ML model), and the like). In some embodiments, the content selection object generated by content selection object generator 106 corresponds to a selection of one of plural candidate content selection machine learning models, where each candidate content selection machine learning model is trained to predict one or more selectable content media items. The one or more selectable content media items can then be presented to at least one simulated user within the simulated environment.

In some embodiments, a candidate content selection machine learning model can be applied to a client device in a production environment such that the one or more selectable content media items the model identifies can, in turn, be presented to at least one real user within the production environment.

Simulated user model selector 108 operates to provide a simulated user model corresponding to a selection of one of a plurality of simulated user models. Each simulated user model is trained to predict a next action of the simulated user(s) in response to a simulated playback input received from the at least one simulated user. A next action (for both a simulated user and a real user) can be, for example, a play, a skip, a pause, a rewind, a forward, and the like.

Session initializer 110 operates to provide session initialization parameter values associated with a simulated media content playback session. In some embodiments, a session initialization parameter value can be any one or any combination of: a value that initializes a start of a session, a value that identifies a starting playlist (e.g., using a playlist identifier (ID), a simulated user ID:playlist ID pair, and the like); one or more values initializing a selected set of simulated users; one or more values initializing pairs of content media items (e.g., in the form of playlists); one or more values initializing a user or content media items, (e.g., in the form of playlists); one or more values initializing pools of users that are being simulated against; and the like. The session initialization parameter values can be entered, for example via I/O interface 126 or obtained from prestored user session initialization configuration files.

In some embodiments, the session initialization parameters are used in a production test environment, where a session for a real user is initialized using session initialization parameter values set, for example, via I/O interface 126 or obtained from prestored user session initialization configuration files.

Content selection object generator 106 can further operate to initialize a content selection object according to the plurality of session initialization parameter values provided by the session initializer 110 to generate an initialized content selection object.

Augmented content selection simulator 104 operates to generate a simulated session including a sequence of predicted simulated user next actions and one or more predicted sets of selectable content items by applying the simulated user model (e.g., selected by simulated user model selector 108) to content items identified by the initialized content selection object (e.g., provided by content selection object generator 106). In some embodiments, each set of the selectable content items is correlated to each next action in the sequence of predicted simulated user next actions.

In some embodiments, candidate content selection simulator 112 operates to register the plurality of simulated user models. In some embodiments, candidate content selection simulator 112 operates to register the candidate content selection machine learning models. This enables, for example, an operator of the simulator augmented content selection system 100 to select whether to implement a candidate content selection machine learning model in an offline or online test environment.

In some embodiments, I/O interface 126 operates to receive a selection of one of the simulated user models. I/O interface 126 can be, for example, configured to receive input corresponding to a selection of one of the simulated user models to test.

In some embodiments, I/O interface 126 operates to receive input from an operator of the simulator augmented content selection system 100 corresponding to a selection of one of the plurality of candidate content selection machine learning models. Alternatively, a configuration file can be used to provide the selection of one of the simulated user models and/or the selection of one of the plurality of candidate content selection machine learning models.

In some embodiments, session initializer 110 also operates to provide augmented content selection simulator 104 interaction data associated with non-simulated users (i.e., real users who are not simulated a priori) and production initialization parameters. Production initialization parameters can include, for example, production settings associated with a production content selection environment such as a predetermined playlist setting associated with the production content selection environment, where the playlist setting can be a position in the playlist at which a session begins. In turn, simulator augmented content selection system 100 further operates to initialize the content selection object by applying the plurality of session initialization parameter values to the plurality of production initialization parameters, thereby generating the initialized content selection object (e.g., for a production content selection environment).

As described above, each simulated user model is trained to predict a next action of the simulated user(s) in response to a simulated playback input received from the at least one simulated user. In some embodiments, a simulated user model is generated by applying (i) predefined attributes of one or more simulated users, (ii) predefined attributes of media content items, or both, to the selected simulated user model.

The predefined attributes of a simulated user can include, for example, a set of scores and summaries corresponding to a simulated user. The predefined attributes of the simulated user can be in the form of a taste profile that contains a record indicating media content tastes of the simulated user. The taste profile of the simulated user contains a simulated understanding of the media content (e.g., music, video, podcast, etc.) activity and preference of that simulated user, enabling personalized recommendations, taste profiling and a wide range of social (e.g., music, video, podcast, etc.) applications. In some embodiments, the taste profile is a representation of media content activities, such as user preferences and historical information about the user's consumption of media content, and can include a wide range of information such as artist plays, media item plays, skips, dates of listen by the user, media content items per day, playlists, play counts, start/stop/skip data for portions of a media content item or album or playlist, contents of collections, user rankings, preferences, and the like. The taste profile can also include simulated media plays, such as websites visited, book titles, movies watched, playing activity during a movie or other presentations, ratings, or terms corresponding to the media, such as “comedy”, “sexy”, etc.

A taste profile can include other information. For example, the taste profile can include libraries and/or playlists of media content items associated with the simulated user. The taste profiles can also include information about the simulated user's relationships with other simulated (or non-simulated) users.

A taste profile can represent a single user or multiple simulated users. Conversely, a single user or entity can have multiple taste profiles. For example, one taste profile can be generated in connection with a simulated user's media content play activity, whereas another separate taste profile can be generated for the same simulated user based on the user's selection of media content items and/or artists for a playlist.

In some embodiments, the user is not simulated but rather a real user and thus the taste profile corresponds to the real user. That is, the taste profile parameter values are based on real history data. Recorded sessions of the real user can be stored in, for example, actual media content playback session database 119.

Predefined attributes of media content can include a media content item title, artist identifier (ID), name of the media content item (e.g., podcast name, album name, video name, etc.), length, genre, mood, era, etc.

In some embodiments, the session initializer 110 further operates to select a recorded session of a real user (e.g., previously stored in actual media content playback session database 119). The session initializer 110 further can operate to initialize the content selection machine learning model to a particular time within the recorded session.

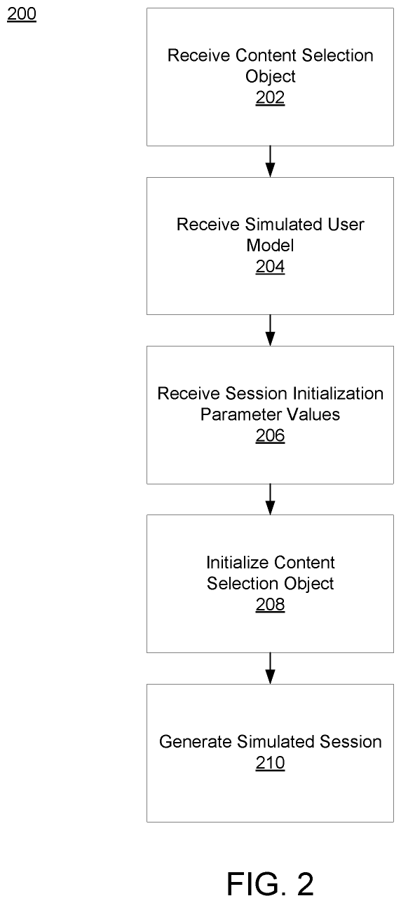

FIG. 2 depicts a simulator augmented content selection procedure 200 for providing simulator augmented content selection in accordance with an example embodiment. In one embodiment, a content selection object receiving operation 202 performs receiving a content selection object corresponding to a selection one of several candidate content selection machine learning models. In some embodiments, each candidate content selection machine learning model trained to predict one or more selectable content media items for at least one simulated user. Content selection object receiving operation 202 can be performed by, for example, augmented content selection simulator 104 obtaining the content selection object from content selection object generator 106.

As described above, a content selection object can be, for example, a set of rules, a plurality of heuristics, a reinforcement learning agent (RL-Agent), a machine learning model (ML model), and the like. In some embodiments, the content selection object corresponds to a selection of one of plural candidate content selection machine learning models, where each candidate content selection machine learning model is trained to predict one or more selectable content media items. The one or more selectable content media items can then be presented to a (e.g., simulated or real) user within the simulated environment.

In turn, a simulated user model selection operation 204 performs receiving a simulated user model corresponding to a selection of one of a plurality of simulated user models. This operation can be performed by, for example, augmented content selection simulator 104 obtaining (e.g., by requesting) the simulated user model from simulated user model selector 108. Simulated user model selection operation 204 may further involve augmented content selection simulator 104 implementing a configuration file that selects one of a plurality of simulated user models. Simulated user model selection operation 204 can also involve augmented content selection simulator 104 requesting via I/O interface an operator to select one of a plurality of simulated user models.

In an example embodiment, each simulated user model is trained to predict a next action of the at least one simulated user in response to a simulated playback input received from the at least one simulated user.

A session initialization operation 206, in turn, performs receiving a plurality of session initialization parameter values associated with a simulated media content playback session. The session initialization operation can be performed by, for example session initializer 110. In some embodiments, one or more of the session initialization parameter values are obtained via the I/O interface by requesting an operator to input one or more of the session initialization parameter values. Alternatively, the session initialization parameter values are obtained from a parameter initialization configuration file.

In turn, a content selection object initialization operation 208 performs initializing the content selection object according to the plurality of session initialization parameter values, thereby generating an initialized content selection object. The content selection object initialization operation can be performed by, for example, the session initializer 110.

A simulated session generation operation 210 performs generating, by applying the simulated user model to content items identified by the initialized content selection object, a simulated session including a sequence of predicted simulated user next actions and one or more predicted sets of selectable content items. In some embodiments, each set of the one or more selectable content items correlated to each next action in the sequence of predicted simulated user next actions. In some embodiments, simulated session generation operation 210 is performed by simulated user model selection operation 204.

In some embodiments, the various parameter values described herein are obtained by augmented content selection simulator 104 via the I/O interface 126 by requesting an operator to input one or more of the parameter values. Alternatively, the parameter values are obtained by augmented content selection simulator 104 from a parameter initialization configuration file.

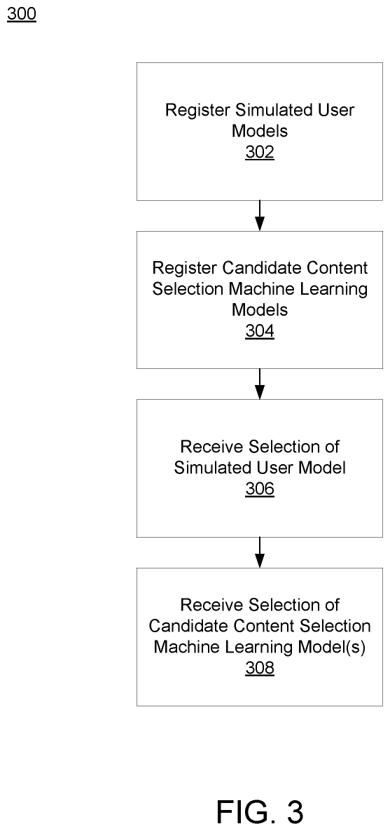

FIG. 3 depicts a registration and selection procedure 300 for registering and selecting simulated user models and candidate content selection machine learning models in accordance with an example embodiment. A simulated user registration operation 302 performs registering the plurality of simulated user models. In an example implementation, simulated user registration operation 302 is performed by the simulated user model selector 108.

In turn, a candidate content selection machine learning registration operation 304 performs registering the plurality of candidate content selection machine learning models. In an example implementation, candidate content selection machine learning registration operation 304 is performed by the candidate content selection simulator 112.

A simulated user model selection receiving operation 306 performs receiving a selection of one of the plurality of simulated user models. In one implementation, simulated user model selection receiving operation 306 is performed by receiving a selection of one of the simulated user models via an input/output interface. In another example implementation, simulated user model selection receiving operation 306 is performed by obtaining the selection via a configuration file.

A candidate content selection machine learning receiving operation 308 performs receiving a selection of one of the candidate content selection machine learning models. In one implementation, candidate content selection machine learning receiving operation 308 is performed by receiving a selection of one of the candidate content selection machine learning models via an input/output interface. In another example implementation, candidate content selection machine learning receiving operation 308 is performed by obtaining the selection via a configuration file.

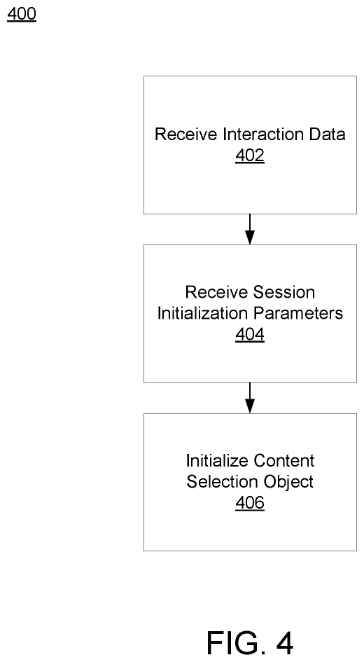

FIG. 4 depicts a content selection object initialization procedure 400 for initializing content selection objects in accordance with an example embodiment. The content selection object initialization procedure 400 involves an interaction data receiving operation 402 that performs receiving (e.g., from a session initializer 110) interaction data associated with non-simulated users and production initialization parameters. Production initialization parameters can include, for example, production settings associated with a production content selection environment such as a predetermined playlist setting associated with the production content selection environment, where the playlist setting can be a position in the playlist at which a session begins. A session initialization parameter receiving operation 404 performs receiving session initialization parameter values. In turn, a content selection object initialization operation 406 performs initializing the content selection object by applying the plurality of session initialization parameter values to the plurality of production initialization parameters, thereby generating an initialized content selection object.

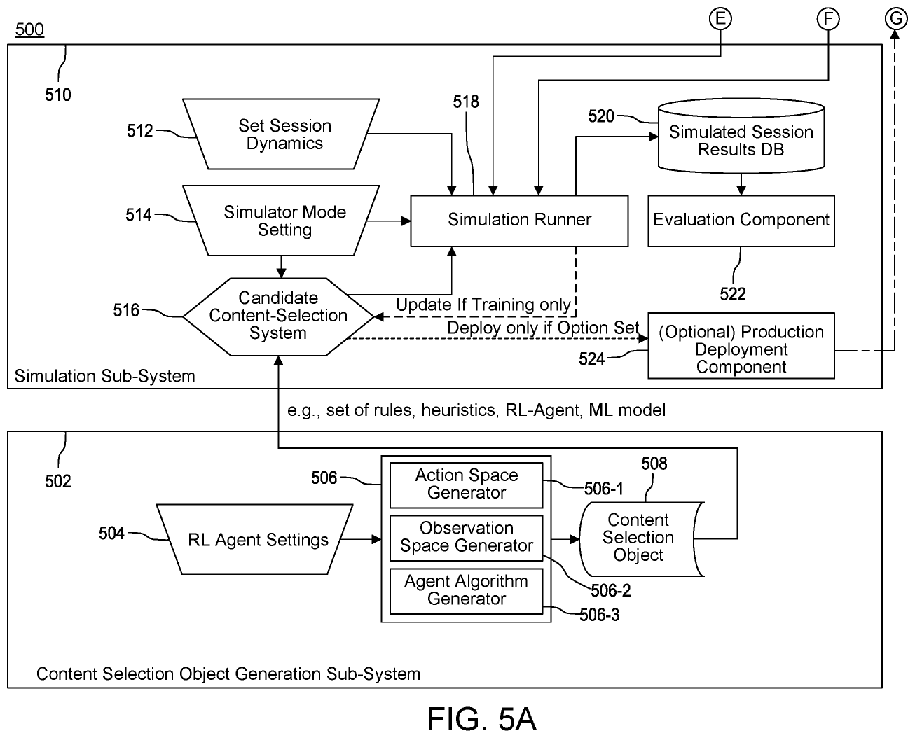

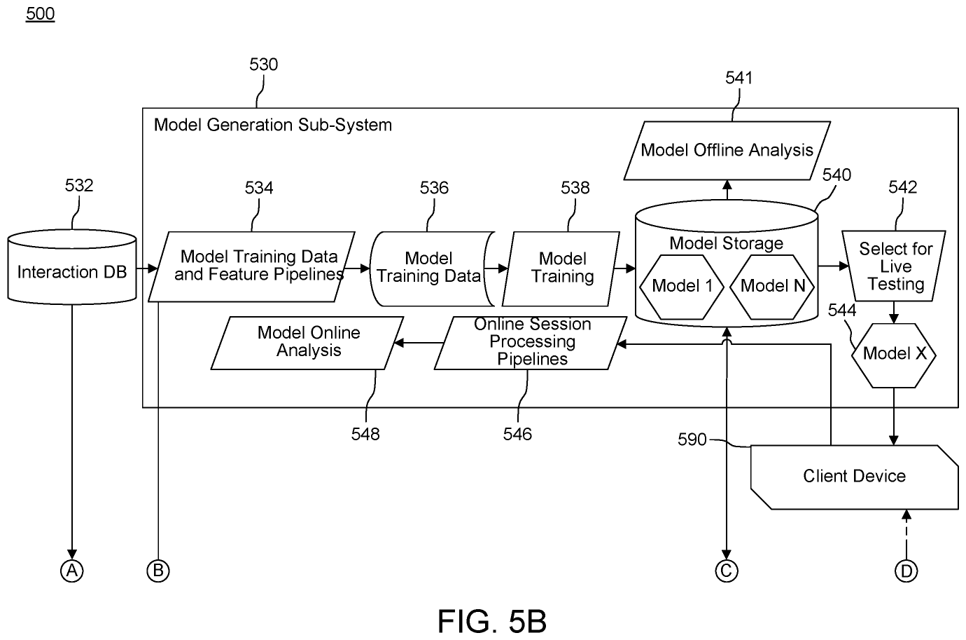

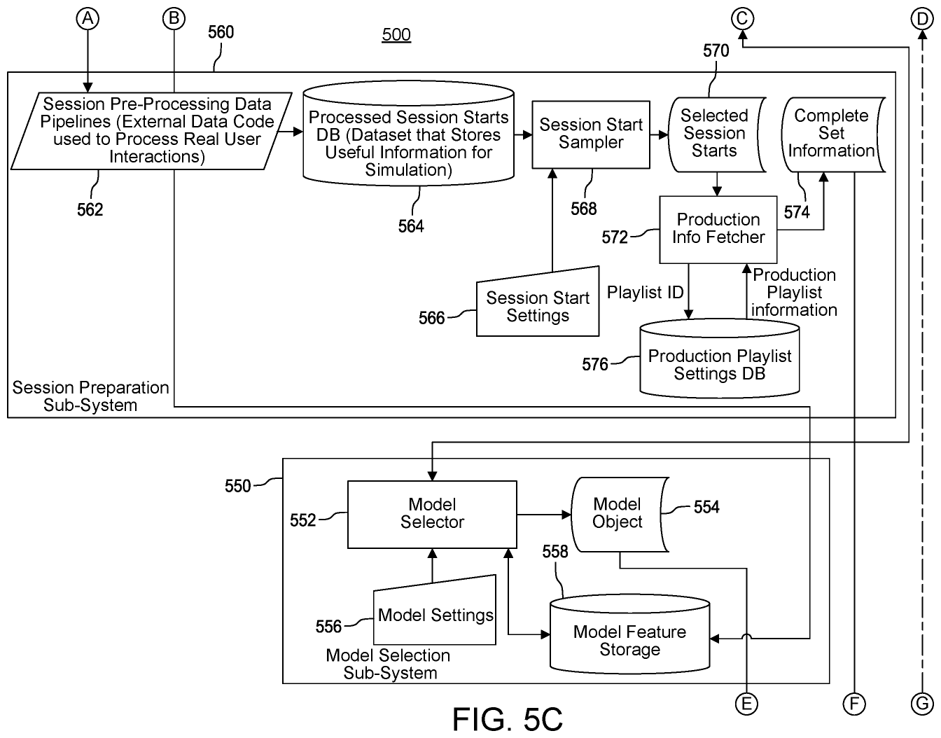

FIG. 5A, FIG. 5B, and FIG. 5C collectively depicts an example system-flow 500 for providing simulator augmented content selection in accordance with an example implementation. For convenience, FIG. 5A, FIG. 5B, and FIG. 5C are individually and collectively referred to simply as FIG. 5. Any features described in connection with this example implementation can also be applicable to the more general embodiment described above in connection with FIGS. 1-4.

Referring first to FIG. 5A, in the example implementation, the content selection system that is being tested is a reinforcement learning (RL) recommendation system. A content selection object generation sub-system 502 operates to define a content selection object 508, which in this implementation is an RL agent, that is used to select content items to be evaluated by a simulation sub-system 510.

In some embodiments, the simulation sub-system 510 uses the content selection object 508 to select content for performing a simulation for a simulated user. In some embodiments, the simulation sub-system 510 uses the content selection object 508 to select content for performing a simulation for a real user.

In the example implementation shown in FIG. 5A, the content selection object generation sub-system 502 is an RL agent specification generator that operates to define a content selection object for performing reinforcement learning on a simulated content selection sequence. The RL agent specification generator (i.e., the content selection object generation sub-system 502) performs an RL agent specification operation that defines the content selection object 508. The content selection object 508, in turn, is used to select content for performing a simulation for a simulated user. As described above, the content selection object 508 in this implementation is an RL agent, but it could alternatively be in the form of a set of rules, heuristics, ML model, and the like.

In some embodiments, a content selection object generator 506 applies RL agent settings 504 to generate the content selection object 508. The RL agent settings 504 can be obtained via a manual operation (e.g., a required manual setting or selection key to system function). In an example implementation, a selection operation receives parameter values, also sometimes referred to as arguments, corresponding to the RL agent settings 504 via an I/O interface 126 (e.g., by an operator inputting the values via the I/O interface 126). In another example implementation, selection operation selects the RL agent settings 504 by obtaining corresponding setting values from a configuration file. In an example implementation, content selection object generator 506 includes an action space generator 506-1, an observation space generator 506-2, and an agent algorithm generator 506-3. Action space generator 506-1 operates to emit actions that are operable for a desired content selection strategy. Observation space generator 506-2 operates to provide the information required for an agent algorithm to emit actions relevant to a content selection strategy. Agent algorithm generator 506-3 operates to codify the algorithmic specifics of a particular content selection object (e.g., rules, heuristics, RL-Agent).

In an example implementation, the outputs of content selection object generator 506 is stored in the candidate content selection ML model database 114 of FIG. 1.

The content selection object 508 is fed to a simulation sub-system 510. Simulation sub-system 510 operates to generate a simulated session including a sequence of predicted simulated user next actions using, at least in part, the content selection object 508. Simulation sub-system 510 also operates to generate one or more predicted sets of selectable content items, where each set of the one or more selectable content items is correlated to each next action in the sequence of predicted simulated user next actions. In other words, simulation sub-system 510 evaluates the performance of the content selection object 508 against a simulated user. In some embodiments, simulation sub-system 510 operates to evaluate the performance of the content selection object 508 against a real user.

Referring to FIG. 5A, in the example implementation, the content selection object 508 is fed to a candidate content selection system 516 of the simulation sub-system 510. The candidate content selection system 516 can be, for example, in the form of an external object. Advantageously, implementing the candidate content selection system 516 as an external object enables the candidate content selection system 516 to be generic.

In some embodiments, candidate content selection system 516 is deployed to the simulation runner 518. In some embodiments, simulation runner 518 operates to provide feedback to the candidate content selection system to train the candidate content selection system 516 (“update if training only”). In some embodiments, candidate content selection system 516 is deployed to a production deployment component 524, which in turn, provisions a client device 590 to test the candidate content selection system 516.

Simulation runner 518 applies a simulated user model to content items identified by an initialized content selection object to generate a simulated session. The simulated session can include, for example, a sequence of predicted simulated user next actions and one or more predicted sets of selectable content items, where each set of the one or more selectable content items correlated to each next action in the sequence of predicted simulated user next actions. The simulated session results are, in turn, stored in a simulated session results database 520.

An evaluation component 522 of the simulation sub-system 510 operates to summarize the results of the simulation runner 518. In some embodiments, the candidate content selection system 516 under test (e.g., a candidate content selection model) is deployed into a production environment using a production deployment component 524. Production deployment component 524 operates to deploy a particular candidate content selection system 516 to a client device.

In some embodiments, optional dynamic arguments can be set for the sessions to be tested (e.g., maximum length of interactions for X number of media content times before ending a session). In an example implementation, set session dynamics 512 are provided through manual input. For example, the set session dynamics 512 input can be a specification of hard rules about the dynamics of how a simulated user can interacts with the session. Simulator mode setting 514 are manual inputs that provide a training mode for the simulation runner 518.

Referring to FIG. 5B, a model generation sub-system 530 operates to produce and provision one or more models that are used to predict user behavior. The model generation sub-system 530 further operates to predict simulated, using the one or more models, user next actions upon being presented with a content item that has been selected from a sequence of content items supplied in a predetermined order. If the content item is a media content item, the model generation sub-system 530 determines, for example, probabilities corresponding to what next actions a simulated user would perform, such as play, skip, forward, and the like.

The model generation sub-system 530 performs training of a model to predict user behavior. In some embodiments, the model generation sub-system 530 uses actual interaction data to train the models.

In an example implementation, an interaction database 532 operates to store interaction data of real users. The interaction data is processed by one or more model training data and feature pipelines 534. Model training data and feature pipelines 534 operates to process the interaction data obtained from the interaction database 532 (e.g., in its raw form) into model training data 536 for training machine learning models. In an example implementation, each of the model training data and feature pipelines 534 comprises instructions which when executed by the processing device 120 formats the interaction data into model training data 536. In some embodiments, model training data and feature pipelines 534 operate to identify the type of data to be selected from interaction database 532 to be used for training the models by the model training operation 538 depending on the nature of a user model to be created. For example, a selection argument can be communicated to the model training data and feature pipelines 534 that causes the model training data and feature pipelines 534 to select a particular type of media content data that has been prestored in interaction database 532 for training a model. The selection argument can thus operate as an instruction to the model training data and feature pipelines 534. In an example use case, the selection can be a value (e.g., an identifier) corresponding to a type of media content (e.g., music, movies, podcasts, and the like). If the selection were music, for example, the model training data and feature pipelines 534 can be configured to retrieve just music interaction data from interaction database 532.

A model training operation 538, in turn, performs applying the model training data 536 to one of several models (e.g., model 1, model 2, . . . , model N). In an example embodiment, a model storage 540 operates to store the models.

In some embodiments, a model offline analysis component 541 performs a set of statistical analyses that are applied to a trained model stored in model storage 540 to determine if the training of the model was successful. In an example implementation, the statistical analysis performed by the model offline analysis component 541 operates to determine training effectiveness based on simulated users. For example, if a model in model storage 540 has been trained to predict tracks that a user would listen from beginning to end (e.g., listen completely without skipping), model offline analysis component 541 can be used to test the model's accuracy. Testing a trained model for its accuracy also is referred to as model validation.

In some embodiments, the offline analysis results generated by the model offline analysis component 541 provide an expectation as to how the model will perform. The model offline analysis component 541 performs the analyses only on simulation data. In some embodiments, a model online analysis component 548 operates to test a model in a test environment with real users. Model online analysis component 548 exposes real users to the decision-making processes of a model in a live environment by measuring how real users react to the model's decision-making processes.

In some embodiments, a live testing selector 542 operates to select one or more models to have tested in a live environment. In some embodiments, live testing selector 542 performs a simulated user model selection operation involving selecting one or more models to have tested in a live environment. The selected one or more models to be tested in a live environment is represented by model X 544, where X represents an identifier of a model selected from the group of models saved in model storage 540, model 1, model 2, . . . , model N. For example, a model stored in model storage 540 can be obtained via a manual operation (e.g., a required manual setting or selection key to system function). In an example implementation the simulated user model selection operation is a manual operation that receives a selection of a model from the model storage 540 to test via an I/O interface (e.g., I/O interface 126 of FIG. 1). In another example implementation, the selection of a model from the model storage 540 to test is performed using a configuration file.

As described above, candidate content selection system 516 can be deployed to a production deployment component 524, which in turn, provisions a client device 590 to test the candidate content selection system 516. The one or more models selected to be tested by live testing selector 542 are provisioned onto client device 590 and executed by a client device 590 to observe next actions (e.g., skip, forward, stop, rewind, etc.). The observed actions are, in turn, fed to one or more online session processing pipelines 546 that operate to format the data to be fed to model online analysis component 548 which operates to analyze the session data.

In an example implementation, each of the online session processing pipelines 546 comprises instructions which when executed by the processing device 120 formats the results received from client device 590. In some embodiments, the online session processing pipelines 546 operate to identify the type of data to be selected from the data received from client device 590 to be used for performing the model online analysis by model online analysis component 548. For example, a selection argument can be communicated to the online session processing pipelines 546 that causes the online session processing pipelines 546 to select a particular type of (e.g., media content) client device 590 has interacted on. The selection argument can thus operate as an instruction to the online session processing pipelines 546. In an example use case, the selection can be a value (e.g., an identifier) corresponding to a type of media content (e.g., music, movies, podcasts, and the like). If the selection were music, for example, the online session processing pipelines 546 can be configured to filter just music interaction data obtained from client device 590. Online session processing pipelines 546 can include other types of instructions related to online execution of the model being tested. For example, online session processing pipelines 546 can filter out sessions of client devices that are being used in a particular context (e.g., a gym, running, driving, walking, and the like).

In an example use case, a real user operating a client device 590 that is executing a model under test (e.g., model X 544) is presented content items in a particular sequence. The client device 590 runs the model (e.g., model X 544) and the next action that is predicted to occur is analyzed by the model online analysis component 548.

In some embodiments, any one or both of the model training data and feature pipelines 534 and online session processing pipelines 546 receive arguments via I/O interface 126. Alternatively, any one or both the model training data and feature pipelines 534 and online session processing pipelines 546 receive arguments via a configuration file.

Referring to both FIGS. 5B and 5C, in some embodiments, the model objects representing the models that are stored in model storage 540 are, in turn, selected by a model selection sub-system 550. The model selection sub-system 550 enables the simulation sub-system 510 to test one or more model objects corresponding to models that have been trained by applying various arguments to available settings. A model object 554 corresponding to the selected model to be tested is fed to the simulation sub-system 510. In an example use case, an operator might select playlists to be tested, where the playlists are known to have particular characteristics to be tested. For example, the playlists that are selected to be tested can be associated with predetermined assumptions of user behavior.

In an example embodiment, data used to generate the model object 554 are provided to a model selector 552 by a model settings component 556. In an example implementation, the data used to generate the model object 554 are provided using a manual input to provide the arguments for the settings. The manual input receives, for example, optional settings, setting selections, and the like.

A model feature storage 558 operates to store feature data for initializing the model object 554. The model feature data used to provision the model object 554 can be data the model object needs to power it, such as features that describe a simulated user, particular content items, and the like. In an example implementation, the model selector 552 obtains data from the model settings component 556 that are applied to the model object 554 to make the predictions about simulated user behavior.

The model object 554 corresponding to the model selected from the model storage 540 of FIG. 5B by the model selector 552 is, in turn, fed to the simulation runner 518 of the simulation sub-system 510. In an example embodiment, simulation runner 518 executes workflows that orchestrate the overall simulation process. For example, the workflows can parse data to be applied to the model object 554.

In an example implementation, the simulation runner 518 operates to receive a content selection object 508, a model object 554, and the complete set information 574 for the sessions, and to run the hypothetical user content interactions to produce both simulated results of users interacting with the content and a summary of expectations about the performance of a content selection object 508. In turn, the simulation runner 518 operates to store the results of those interactions for evaluation in simulated session results database 520.

Generally, session preparation sub-system 560 operates to utilize observed interaction data corresponding to user interactions of real users and production features (e.g., production settings such as content item tracks that are available) to enable the recreation of a production content selection environment. In an example implementation, the session preparation sub-system 560 operates to initialize the starting points for a simulation. Any number of simulated users can be paired with any number of sets of content items. For example, if X simulated users and Y playlists are being tested, each simulated user 1, 2, . . . , X can be simulated against each playlist 1, 2, . . . , Y, where X and Y are integers. More particularly, session preparation sub-system 560 operates to provide session initialization parameter values associated with a simulated media content playback session. In some embodiments, a session initialization parameter value can be any one or any combination of: a value that initializes a start of a session, a value that identifies a starting playlist (e.g., using a playlist identifier (ID), a simulated user ID:playlist ID pair, and the like); one or more values initializing a selected set of simulated users; one or more values initializing pairs of content media items (e.g., in the form of playlists); one or more values initializing a user or content media items, e.g., in the form of playlists; on or more values initializing pools of users that are being simulated against; and the like. The session initialization parameter values can be entered, for example via I/O interface 126 or obtained from prestored configuration files.

In some embodiments, interaction data of real users stored in interaction database 532 is fed to session one or more pre-processing data pipelines 562 of the session preparation sub-system 560. Pre-processing data pipelines 562 perform data extraction and processing necessary to generate sets of session metrics representing hypothetical user-sessions to be analyzed. This enables hypothetical interactions of simulated users interacting with predetermined sets of content items. A user-session metric can also include a session start for the simulated users. Another example of user-session metrics includes session metrics corresponding to a particular environment of a user (e.g., an environment that simulates hypothetical interactions between users and country music radio stations).

Session start settings 566 are, in turn, supplied to a session start sampler 568. Session start sampler 568 operates to point to the data set(s) stored in processed session starts database 564 and using the pointers, retrieve selected session starts 570. In an example implementation, requested session start settings 566 can be manually input e.g., via I/O interface 126. A session start setting 566 can be for example a request for session starts that indicate pairs of users and particular playlists. Once retrieved, each of the selected session starts 570 is fed into a production information fetcher 572. The production information fetcher 572, in turn, determines which content items can be reached by the particular simulated user. For example, production information fetcher 572 can involve determining which media content times can be used for a particular genre. In an example embodiment, production information fetcher 572 operates to retrieve production playlist information from a production playlist settings database 576 by issuing a command for production playlist information for a particular playlist identifier. The production playlist settings obtained from production playlist settings database 576 are, in turn, used to generate complete set information 574 for the simulation. The production playlist settings can include, for example a list of tracks, a list of videos, a list of podcast episodes, and the like. In some embodiments, production playlist settings can also include sets of instructions that enable the recreation of a production selection environment. The complete set information 574 can includes this data and instructions. In an example use case the complete set information 574 contains data identifying users (e.g., user A) and a playlist identifier (e.g., playlist B), and the identifiers for the tracks corresponding to the playlist pointed to by the playlist identifier.

The example embodiments described herein may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more memory cards (e.g., flash memory) for program and data storage, and a random-access memory, for temporary data and program instruction storage. From a software standpoint, a CPU typically includes software resident on a storage media (e.g., a memory card), which, when executed, directs the CPU in performing transmission and reception functions. The CPU software may run on an operating system stored on the storage media, such as, for example, UNIX or Windows, iOS, Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, that may include an article of manufacture on a machine accessible or non-transitory computer-readable medium (i.e., also referred to as “machine readable medium”) having instructions. The instructions on the machine accessible or machine-readable medium may be used to program a computer system or other electronic device. The machine-readable medium may include, but is not limited to, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

A graphic processing unit (GPU) is a hardware component that is typically used to enhance application and system performance, particularly when used in cooperation with a central processing unit (CPU). GPUs can also perform parallel processing with large blocks of data to deliver enormous computational capability in areas like machine learning. In some embodiments, one or more GPUs are programmed to train the models described herein.

It should be understood that not all of the components are required to practice the invention, and variations in the arrangement and type of the components may be made without departing from the spirit or scope of the invention. As used herein, the term “component” is applied to describe a specific structure for performing specific associated functions, such as a special purpose computer as programmed to perform algorithms (e.g., processes) disclosed herein. The component can take any of a variety of structural forms, including: instructions executable to perform algorithms to achieve a desired result, one or more processors (e.g., virtual or physical processors) executing instructions to perform algorithms to achieve a desired result, or one or more devices operating to perform algorithms to achieve a desired result.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for providing a simulator augmented content selection, comprising:
a content selection object generator configured to generate a content selection object corresponding to a candidate content selection machine learning model trained to predict one or more selectable content media items for at least one simulated user;
a simulated user model selector configured to provide a simulated user model corresponding to a simulated user model trained to predict a next action of the at least one simulated user in response to a simulated playback input received from the at least one simulated user;
a session initializer configured to initialize the content selection object according to a plurality of session initialization parameter values, thereby generating an initialized content selection object, where the plurality of session initialization parameter values correspond to a simulated media content playback session; and
an augmented content selection simulator configured to apply the simulated user model to content items identified by the initialized content selection object to generate a simulated session including a sequence of predicted simulated user next actions and one or more predicted sets of selectable content items, each set of the one or more selectable content items correlated to each next action in the sequence of predicted simulated user next actions.

2. The system according to claim 1, further comprising:
a candidate content selection simulator configured to register a plurality of candidate content selection machine learning models, wherein the candidate content selection machine learning model is obtained by a selection of one of the plurality of candidate content selection machine learning models, wherein each of the plurality of candidate content machine learning models is trained to uniquely predict one or more selectable content media items for at least one simulated user.

3. The system of claim 2, further comprising:
an input/output interface configured to receive a selection of one of the plurality of candidate content selection machine learning models.

4. The system according to claim 1, further comprising:
a candidate content selection simulator configured to register a plurality of simulated user models, wherein the simulated user model is obtained by a selection of one of the plurality of simulated user models, wherein each simulated user model is trained to uniquely predict a next action of the at least one simulated user in response to a simulated playback input received from the at least one simulated user.

5. The system of claim 4, further comprising:
an input/output interface configured to receive a selection of one of the plurality of simulated user models.

6. The system of claim 1, the simulated user model selector further configured to:
generate the simulated user model by applying any one of (i) a plurality of predefined attributes of the one or more simulated users, (ii) a plurality of predefined attributes of media content items, or (iii) a combination of (i) and (ii), to the selected simulated user model.

7. The system of claim 1, the session initializer configured to:
receive interaction data associated with a plurality of non-simulated users and a plurality of production initialization parameters, and
initialize the content selection object by applying the plurality of session initialization parameter values to the plurality of production initialization parameters, thereby generating the initialized content selection object.

8. The system of claim 1, wherein the session initializer is further configured to:
select a recorded session of a real user, and
initialize the candidate content selection machine learning model to a particular time within the recorded session.

9. A method for providing a simulator augmented content selection, comprising the steps of:
receiving a content selection object corresponding to a candidate content selection machine learning model trained to predict one or more selectable content media items for at least one simulated user;
receiving a simulated user model corresponding to a simulated user model trained to predict a next action of the at least one simulated user in response to a simulated playback input received from the at least one simulated user;
initializing the content selection object according to a plurality of session initialization parameter values, thereby generating an initialized content selection object, where the plurality of session initialization parameter values correspond to a simulated media content playback session; and
applying the simulated user model to content items identified by the initialized content selection object to generate a simulated session including a sequence of predicted simulated user next actions and one or more predicted sets of selectable content items, each set of the one or more selectable content items correlated to each next action in the sequence of predicted simulated user next actions.

10. The method according to claim 9, further comprising:
registering a plurality of candidate content selection machine learning models; and
receiving a selection of one of a plurality of candidate content selection machine learning models to obtain the candidate content selection machine learning model, wherein each of the plurality of candidate content machine learning models is trained to uniquely predict one or more selectable content media items for at least one simulated user.

11. The method according to claim 9, further comprising:
registering a plurality of simulated user models;
receiving a selection of one of the plurality of simulated user models, to obtain the simulated user model, wherein each simulated user model is trained to uniquely predict a next action of the at least one simulated user in response to a simulated playback input received from the at least one simulated user.

12. The method of claim 9, further comprising:
generating the simulated user model by applying any one of (i) a plurality of predefined attributes of the one or more simulated users, (ii) a plurality of predefined attributes of media content items, or (iii) a combination of (i) and (ii), to the selected simulated user model.

13. The method of claim 9, further comprising:
receiving interaction data associated with a plurality of non-simulated users and a plurality of production initialization parameters; and
initializing the content selection object by applying the plurality of session initialization parameter values to the plurality of production initialization parameters, thereby generating the initialized content selection object.

14. The method of claim 9, further comprising:
selecting a recorded session of a real user; and
initializing the candidate content selection machine learning model to a particular time within the recorded session.

15. A non-transitory computer-readable medium having stored thereon one or more sequences of instructions for causing one or more processors to perform: and
receiving a content selection object corresponding to a candidate content selection machine learning model trained to predict one or more selectable content media items for at least one simulated user;
receiving a simulated user model corresponding to a simulated user model trained to predict a next action of the at least one simulated user in response to a simulated playback input received from the at least one simulated user;
initializing the content selection object according to a plurality of session initialization parameter values, thereby generating an initialized content selection object, where the plurality of session initialization parameter values correspond to a simulated media content playback session; and
applying the simulated user model to content items identified by the initialized content selection object to generate a simulated session including a sequence of predicted simulated user next actions and one or more predicted sets of selectable content items, each set of the one or more selectable content items correlated to each next action in the sequence of predicted simulated user next actions.

16. The non-transitory computer-readable medium of claim 15, further having stored thereon a sequence of instructions for causing the one or more processors to perform:
registering a plurality of candidate content selection machine learning models; and
receiving a selection of one of a plurality of candidate content selection machine learning models to obtain the candidate content selection machine learning model, wherein each of the plurality of candidate content machine learning models is trained to uniquely predict one or more selectable content media items for at least one simulated user.

17. The non-transitory computer-readable medium of claim 15, further having stored thereon a sequence of instructions for causing the one or more processors to perform:
registering a plurality of simulated user models; and
receiving a selection of one of the plurality of simulated user models, to obtain the simulated user model, wherein each simulated user model is trained to uniquely predict a next action of the at least one simulated user in response to a simulated playback input received from the at least one simulated user.

18. The non-transitory computer-readable medium of claim 15, further having stored thereon a sequence of instructions for causing the one or more processors to perform:
generating the simulated user model by applying any one of (i) a plurality of predefined attributes of the one or more simulated users, (ii) a plurality of predefined attributes of media content items, or (iii) a combination of (i) and (ii), to the selected simulated user model.

19. The non-transitory computer-readable medium of claim 15, further having stored thereon a sequence of instructions for causing the one or more processors to perform:
receiving interaction data associated with a plurality of non-simulated users and a plurality of production initialization parameters; and
initializing the content selection object by applying the plurality of session initialization parameter values to the plurality of production initialization parameters, thereby generating the initialized content selection object.

20. The non-transitory computer-readable medium of claim 15, further having stored thereon a sequence of instructions for causing the one or more processors to perform:
selecting a recorded session of a real user; and
initializing the candidate content selection machine learning model to a particular time within the recorded session.
